(19) United States
(12) Patent Application Publication
(10) Pub. No.: US 2008/0163547 A1
(43) Pub. Date: Jul. 10, 2008

(54) APPARATUS FOR IRRIGATION AND DRAINAGE IN A PLANT VASE

(76) Inventors: Yehonatan Sade, Macabim (IL); Liav Amar, Reut (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/620,822

(22) Filed: Jan. 8, 2007

(51) Int. Cl. A01G 25/00; A01G 9/02

(52) U.S. Cl. 47/66.6; 47/79

(57) ABSTRACT

The present invention is an apparatus for the irrigation and drainage of fluids in a plant vase 100. The present invention includes a plant vase 100 that has a sculptured head section 13. Sculptured head section 13 may be sculptured to resemble the head of a famous character or a persona. Sculptured head section 13 includes an irrigation ring 21 at its upper perimeter that allows the easy and convenient irrigation of a plant 33. Plant vase 100 farther includes a transparent neck section 15 and a transparent container 16 and a float 17 that enable a visible indication of the excess drainage fluids quantity.

### FIELD OF THE INVENTION

The present invention generally relates to the field of irrigation and drainage of fluids in plant vases and more specifically, the present invention is an apparatus for irrigating and draining excess fluids in a plant vase.

### BACKGROUND OF THE INVENTION

Plant vases, plant pots and flowerpots in various configurations and designs have been disclosed in the related art. For example, U.S. Pat. No. 6,298,599 by Roberta Weiner discloses a three-dimensional sculptured plant vase having the appearance of a sculptured head and a plant with leaves, wherein the plant leaves appear to be the hair of the sculptured head. Weiner's sculptured plant vase enables drainage of excess fluids through a plug placed at the bottom of the sculptured plant vase. Weiner's sculptured plant vase has an interior plant chamber for receiving a potting soil and a plant.

In Weiner's patent, draining excess fluids, such as excess irrigation water, requires pulling out the plug at the bottom of the sculptured plant vase. In the said patent, there is no visible indication of excess fluids quantity and a user of such a plant vase cannot tell if the plant has been over-irrigated until the user pulls out the plug to drain the excess fluids.

U.S. Pat. No. 5,549,500 by Manoah Ron discloses an animal figurine that contains a body of plant nutrient material and a bed of plant seeds. The grass stalks sprouting from the seeds grow through a scalp portion of the animal figure and appear as the figure's hair. In other configurations of this patent, the sprouting stalks may be planted to appear as the animal figurine's fur. In Manoah's patent, drainage of excess fluid is facilitated by a tray or a plate that is placed underneath the animal figurine.

Sculptured plant vases and decorative plant pots usually have drainage holes in the bottom of the vase or pot. This type of drainage requires a tray or other container that can hold the excess fluids. None of the above patents discloses a drainage mechanism in which the quantity of excess fluids in a plant vase can be visibly indicated before drainage is actually carried out. Due to the lack of some visible indicator of excess fluids in related art, one must resort to, for example, lifting up the drainage tray to see if it is full and then empty the tray or pulling out a plug at the bottom of the plant vase to drain the excess fluids.

Furthermore, none of the related art patents teaches or discloses an irrigation mechanism that is implemented as a part of the plant vase or pot itself. Moreover, none of the related art teaches or discloses an apparatus for irrigation and drainage in a plant vase.

None of the related arts discloses a method for promoting the sales of such a product by designing the plant vases or pots in shapes of popular and famous personas and characters.

### SUMMARY OF THE INVENTION

The present invention is an apparatus for irrigation and drainage in a plant vase. The plant vase may have the shape of a head with a cavity for inserting a plant pot. The head of the plant vase may be designed as the head of a famous or popular character or persona.

The plant pot may have soil and plant nutrient substances and a plant or plant seeds that may grow into a plant. According to the present invention, the plant may appear as, for example, the hair of the persona or character and may furthermore be shaped or styled by a user to, for example, fit the current hairstyle of the said persona or character.

According to the present invention, the apparatus includes an irrigation ring, which is a substantially annular dripping pipe with an opening for introducing irrigation fluids such as water and fluid nutrient fertilizers. The apparatus includes a drainage mechanism that also functions as the supporting base of the plant vase. The drainage mechanism includes a transparent drainage tube that enables visual indication of the excess fluids that have drained down from the plant pot.

The present invention may be a popular and fun accessory for children and adolescents, as well as adults, allowing them to nurture and grow their favorite persona or character, where the irrigation and drainage apparatus facilitates easy and convenient plant treatment.

The present invention uses the users' affection and admiration to popular characters and personas to facilitate in educating the users for nourishment and treatment of plants as well as knowledge of the world of nature. The present invention may include instruction and guiding booklet that provides explanation regarding the use of the vase as well as instructions and information regarding plants optimal growing treatments and conditions.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1a and FIG. 1b are schematic illustrations of an apparatus for irrigation and drainage in a plant vase, according to some embodiments of the present invention;

FIG. 2 is a schematic illustration of an irrigation mechanism, according to some embodiments of the present invention;

FIG. 3 is schematic illustration of a drainage mechanism, according to some embodiments of the present invention;

FIG. 4 is a schematic illustration of a plant pot that is designed to fit in a plant vase, according to some embodiments of the present invention; and

FIG. 5 is a schematic illustration of a decorative bow for a plant vase, according to some embodiments of the present invention.

FIG. 6 is a schematic illustration of a supporting structure for a plant vase, according to some embodiments of the present invention.

The drawings together with the description make apparent to those skilled in the art how the invention may be embodied in practice.

No attempt is made to show structural details of the invention in more detail than is necessary for a fundamental understanding of the invention.

### DETAILED DESCRIPTIONS OF SOME EMBODIMENTS OF THE INVENTION

The present invention is an apparatus for irrigation and drainage in a plant vase 100. Plant vase 100 includes a sculptured head section 13 that may have the shape of, for example, the head of a famous character or persona.

According to some embodiments of the present invention, plant vase 100 is able to hold therein a plant pot 200 that contains a plant 33 and a growing medium such as, for example, soil or sand. When pot 200 is seated in plant vase 100, the stems and leaves of plant 33 may appear as, for example, the hair of the head shape.

An embodiment is an example or implementation of the inventions. The various appearances of “one embodiment,” “an embodiment” or “some embodiments” do not necessarily all refer to the same embodiments. Although various features of the invention may he described in the context of a single embodiment, the features may also be provided separately or in any suitable combination. Conversely, although the invention may be described herein in the context of separate embodiments for clarity, the invention may also be implemented in a single embodiment

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

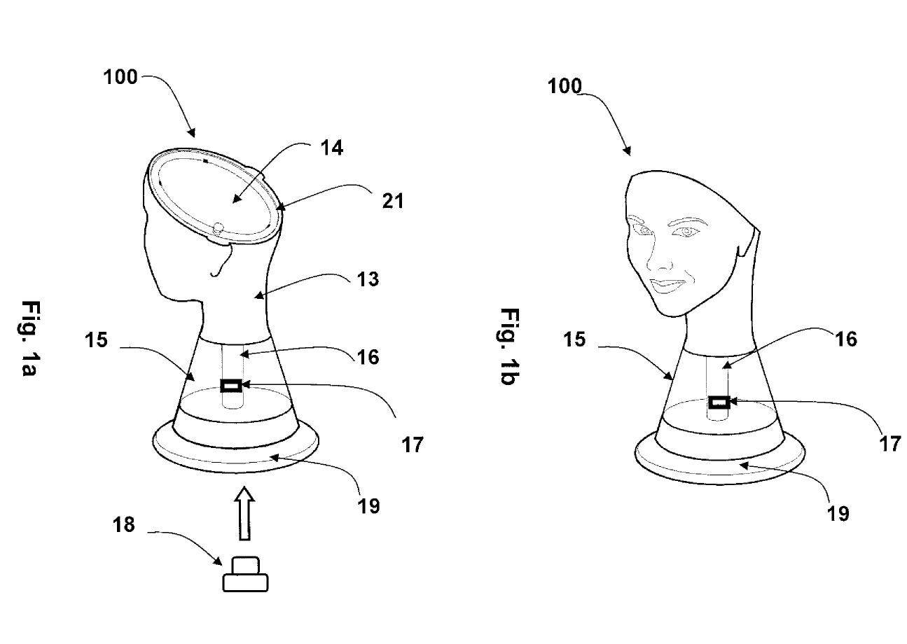

Reference is now made to FIG. 1a and FIG. 1b, which schematically illustrate an apparatus for irrigation and drainage, wherein the irrigation and drainage apparatus may take the shape of a plant vase 100, according to some embodiments of the present invention. FIG. 1a shows a back view of plant vase 100 and FIG. 1b shows a front view of plant vase 100. Said plant vase 100 comprises:
a sculptured head section 13 that has an opening at its bottom. The exterior of sculptured head section 13 resembles, for example, a head. Head section 13 is further equipped with an internal head cavity 14 for holding a plant pot 200.
a transparent neck section 15 that holds the sculptured head section 13.
a transparent container 16, that is placed within transparent neck section 15; transparent container 16 perimeter wall is sealed; a first opening of transparent container 16 is connected to the opening at the bottom of sculptured head section 13 and a second opening of transparent container 16 can be sealed with a valve 18.
a valve 18 that enables sealing of transparent container 16.
a float 17 that is placed inside transparent container 16, which enables the indication of the excess fluid level.
a vase base 19 that facilitates the stabilizing of plant vase 100.
an irrigation ring 21 that is placed at the upper perimeter of sculptured head section 13.
   The transparent container 16 and transparent neck section 15 enable the visibility of float 17. According to some embodiments of the present invention, irrigation ring 21, float 17 and valve 18 may be detachable.

The present invention enables the irrigation of a plant through irrigation ring 21, and the drainage of excess fluids from a plant through transparent container 16.

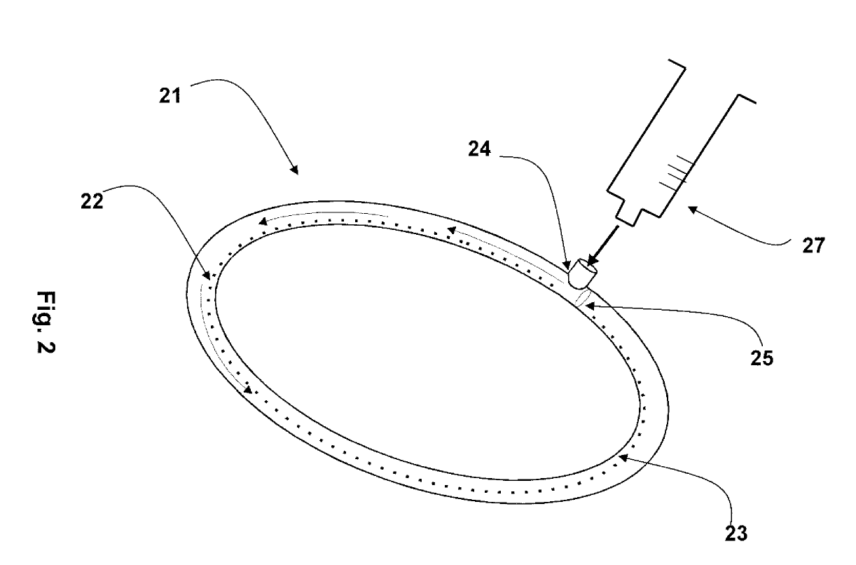

Reference is now made to FIG. 2, which schematically illustrates an irrigation ring 21, which is an irrigation mechanism, according to embodiments of the present invention. Irrigation ring 21 comprises a dripping pipe 22 with holes 23 along the bottom of its perimeter, an irrigation opening 24 of dripping pipe 22 that enables insertion of, for example, plant nutrient fluids into dripping pipe 22. Dripping pipe 22 may also include an inner sealer 25 to enable the smooth circulation of fluids within dripping pipe 22. Sealer 25, dripping pipe 22 and irrigation opening 24 may be molded together as a single piece that comprises an irrigation ring 21. According to some embodiments of the present invention, plant nutrient fluids may be inserted through irrigation ring 21 to irrigate a plant 33. According to some embodiments of the present invention, plant nutrient fluids can be inserted into irrigation ring 21 through irrigation opening 24 by a syringe 27.

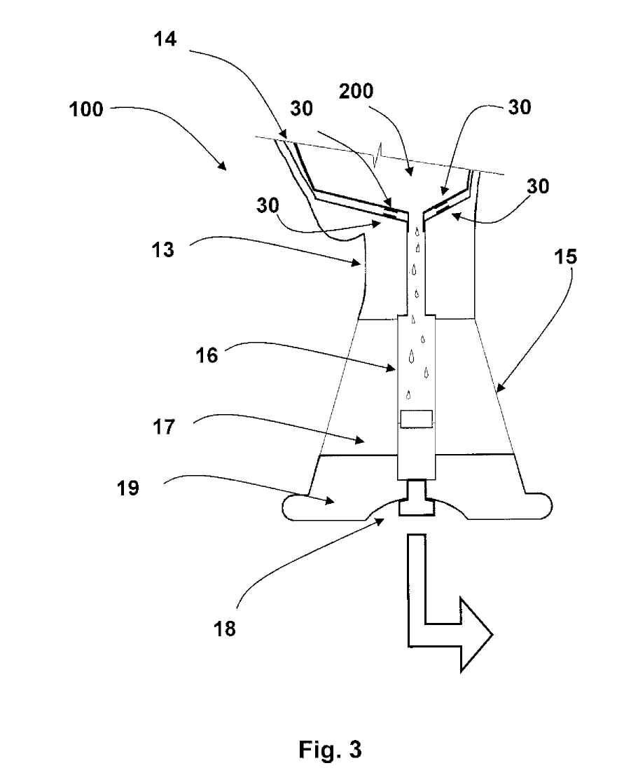

Reference is now made to FIG. 3, which schematically illustrates mechanism for drainage of excess fluids in plant vase 100, according to some embodiments of the present invention. After, for example, watering pot 200, the excess fluids drain through drainage opening 31 into transparent container 16. As the drained fluids fill transparent container 16, float 17, for example, rises and indicates the level of the drained fluids. When float 17 reaches a predefined level, for example, a level marked on transparent container 16, then valve 18 that seals container 16 may be removed from container 16 in order to empty transparent container 16.

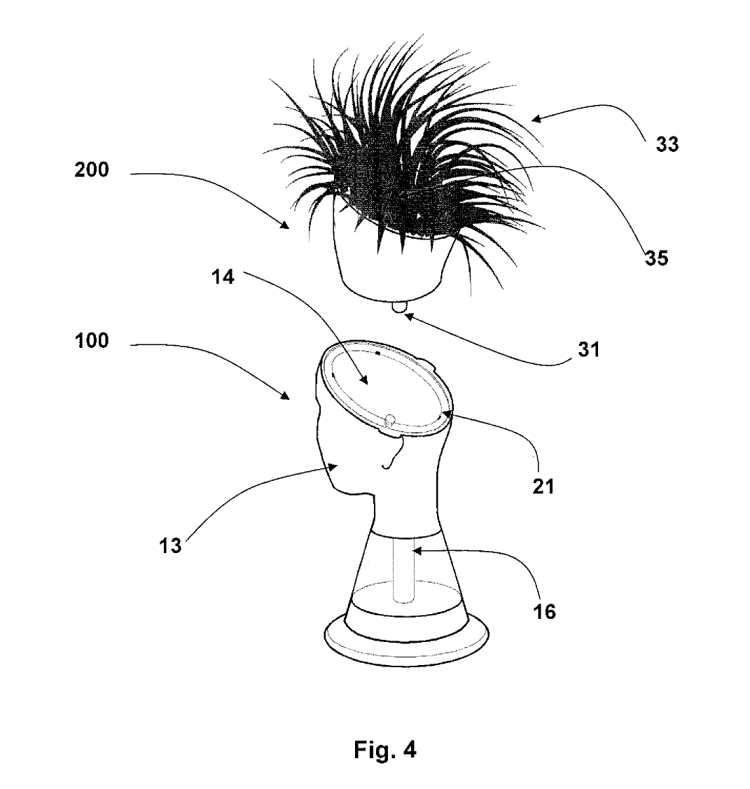

According to embodiments of the present invention, a plant pot 200 may be inserted into plant vase 100 head cavity 14, as shall be further specified in the following paragraph, relating to FIG. 4. At least two couplers 30 may attach plant pot 200 to head cavity 14. Said couplers may be, for example, magnets, stickers, or any other coupling mechanisms that allow head cavity 14 and plant pot 200 to be attached in a way that enables easy removing of plant pot 200 and reattaching of a different plant pot 200.

Reference is now made to FIG. 4, which schematically illustrates plant pot 200 intended for use with plant vase 100, wherein plant pot 200 fits in size and shape to be inserted into head cavity 14 of sculptured head section 13. Plant pot 200 has a drainage opening 31 at the bottom of plant pot 200. Drainage opening 31 may be, for example, in the shape of a tube and may be inserted to transparent container 16. Plant pot 200 includes a plant 33 and soil 35 that may be composed of, for example, plant nutrient substances. Plant 33 may appear to be the hair of plant vase 100 when plant pot 200 is placed in plant vase 100. The drainage opening 31 of plant pot 200 enables draining of excess fluids down through transparent container 16.

According to some embodiments of the present invention, irrigation ring 2t may be removed from plant vase 100 in order to facilitate inserting plant pot 200 into head cavity 14, and then irrigation ring 21 may be place back in plant vase 100 in order to irrigate plant 33.

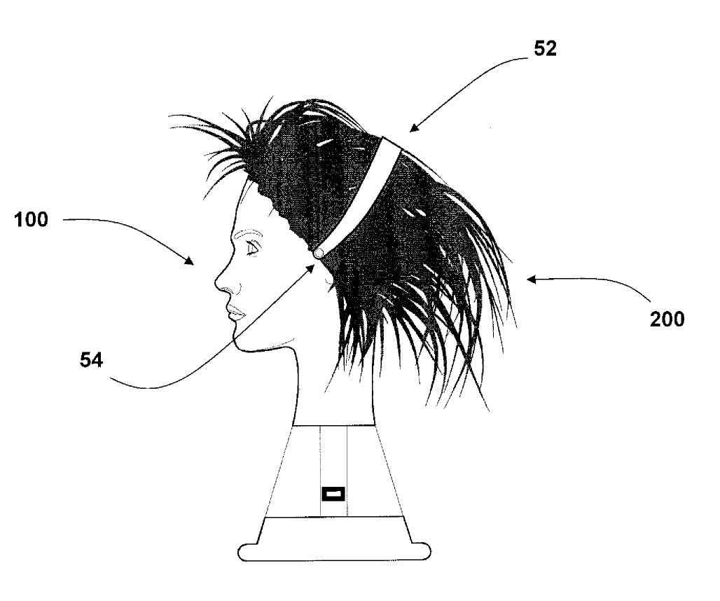

Reference is now made to FIG. 5, which schematically illustrates a decorative bow 52 for a plant vase 100, according to some embodiments of the present invention. Decorative bow 52 may be attached, for example, to the external perimeter of sculptured head section 13 of plant vase 100. Furthermore, decorative bow 52 may include at least one connector 54 at each end of decorative bow 52. Connectors 54 may be attached to at least two spots of sculptured head session 13.

According to some embodiments of the present invention, decorative bow 52 and connectors 54 may be made of any decorative material, such as plastic, fabric, metal, or any combination of materials. According to some embodiments of the present invention, decorative bow 52 may be of different sizes, colors, shapes and textures and connectors 54 may be connected to the perimeter of sculptured head section 13. Various placements of decorative bow 52 may create the appearance of various hairstyles, such as a pulled back hairstyle, a ponytail, etc.

According to some embodiments of the present invention, connectors 54 may also be used to enable attachment of other decorative accessories such as flowers, ribbons, etc.

According to some embodiments of the present invention, sculptured head section 13 of plant vase 100 may be shaped to create, for example, three dimensional faces that resemble the faces of, for example, famous characters and personas. According to such embodiments, plant 33 may appear as the hair of the famous persona or character. The type of plant 33 may be chosen according to characteristics that, for example, resemble hair. Furthermore, plant 33 may be pruned to, for example, fit the hairstyle of the famous persona or character.

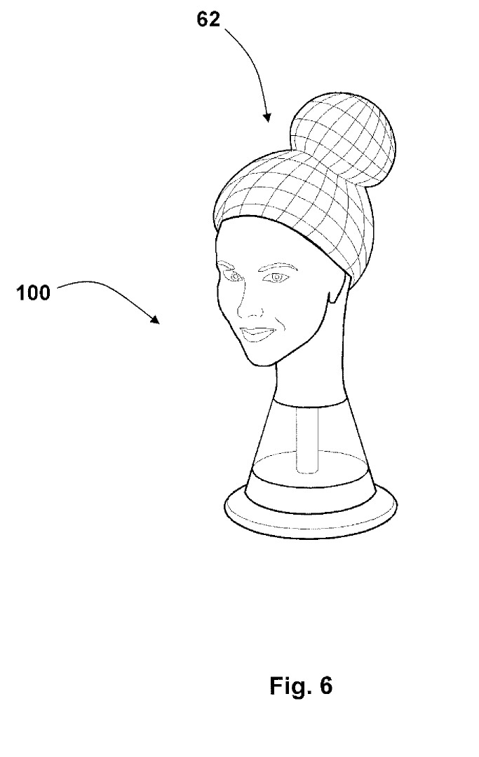

According to some embodiments of the present invention, plant vase 100 may further enable attaching of a supporting structure 62. Said supporting structure 62 may be in a form of at least one supporting rod, a coarse surfaced board (to allow climber plants, for example a climbing surface), or a net, as illustrated in FIG. 6, according to embodiments of supporting structure 62. Supporting structure 62 enables plant 33 to grow in the shape of a desired hairstyle. For example, the shape of the hairstyle of the famous character or persona that head section 13 is associated with. Supporting structure 62 may further enable changing and designing of various hairstyles and replacement of supporting structure 62 with different and various designs.

According to some embodiments of the present invention, plant 33 may be sprayed with organic plant sprays that enable coloring of plant 33 in various colors. As a result, the color of pruned plant 33 may appear as the hairstyle and color of the famous persona or character.

According to some embodiments of the present invention, plant vase 100 may be marketed and sold as a kit together with plant pot 200, irrigation syringes 27, decorative bow 52, supporting structure 62 and a set of plant sprays. The said kit may help to promote the sales of the present invention. For example, sculptured head section 13 may be in the shape of a famous soccer player's head. Plant 33 may be sprayed with the color of the famous soccer player's hair and pruned to fit the player's hairstyle. The said kit may further include a guiding booklet, wherein said booklet may includes educational information and instructions regarding the treatment of plants, written and graphic information relating to plants and written and graphic information relating to the famous character or persona.

According to some embodiments of the present invention, the booklet may further include information regarding growing conditions that enable plant 33 to grow faster or slower, according to fertilizers measures, light conditions and irrigation measurements. Irrigation measures may also be indicated in syringe 27.

According to some embodiments of the present invention, sales promotion of the present invention may also include updating the buyers of plant vase 100 or the kit, with the latest news and information relating to the specific persona or character of their plant vase 100. Updating of the buyers may be carried out through, for example, short message service (SMS) and multimedia messaging service (MMS).

According to some embodiments of the present invention, such SMS and MMS updating of the buyer may be carried out through a messages device that may be integrated within plant vase 100. The messages device may be a screen or a speaker that has a receiver. The message information may be automatically received by the receiver and represented on the screen, through the speaker or both. For example, plant vase 100 with a sculptured head section 13 of a famous soccer player may be further equipped with a screen and a receiver for receiving SMS messages of gossip and news related to said player.

What is claimed is:

1. An apparatus for irrigation and drainage of fluids in a plant vase, wherein said plant vase comprises:
a sculptured head section, wherein said sculptured head section is sculptured to resemble the face of a famous character or persona, and wherein said sculptured head section includes an inner cavity,
a plant pot that is inserted into the inner cavity of the sculptured head section, wherein said plant pot includes at least one opening at its bottom and contains a plant, soil, and plant nutrient substances, and wherein the leaves and stalks of the plant appear as the hair of the said sculptured character or persona
a neck section that connects to the head section and includes a base section that supports said head section,
a container for containing the excess fluids, wherein said container is placed within the neck section and wherein said container also enables indication of the excess fluids,
a valve for sealing the container, wherein said valve is detachable to enable empting of the container,
an irrigation ring that includes a substantially annular dripping pipe that enables fluid dripping and an opening for the insertion of plant nutrient fluids, wherein said irrigation ring is placed at the upper perimeter of the sculptured head section.

2. The apparatus of claim 1, wherein said sculptured head section is sculptured to resemble the face of a famous character or persona, includes a famous human, animal and cartoon figure.

3. The apparatus of claim, 1, wherein said plant vase and plant pot are made of at least one material such as plastic, clay, metal, glass, and wood.

4. The apparatus of claim 1, wherein said neck section and said container provide a visible indication of excess fluids drained from the plant, including substantially transparent substances to allow visibility of fluids level within the container.

5. The apparatus of claim 1, wherein said container enables visible indication of excessive plant fluids drained from the plant, further including a float that is inserted into the container for farther improvement of indication of excess fluids.

6. The apparatus of claim 1 further including a detachable decorative how that connects to the upper perimeter of the sculptured head section.

7. The apparatus of claim 1 further including a messages device, wherein said message device has a receiver, a screen and a speaker for presenting of said messages.

8. The messages device of claim 7, wherein said messages device enables electronic receiving of messages that are related to the famous character or persona.

9. The apparatus of claim 1, further including a supporting structure that enables the shaping of the plant's leaves and stalks into a desirable three-dimensional design.

10. The apparatus of claim 1 wherein the plant color can be changed for to fit the color of the famous persona or character's hair color by using an organic plant spray.

11. The apparatus of claim 1 wherein the irrigation ring is filled through a syringe, wherein said syringe enables indication of irrigation fluids quantities to enable the user's control over the plant growth-rate to fit hair design.

12. The apparatus of claim 1, wherein the plant pot is inserted into the inner cavity of the sculptured head section, further includes at least two couplers that enable attachment of the plant pot to the said inner cavity.

13. The apparatus of claim 12 wherein said couplers are one of the following type: magnetic couplers, sticker couplers and mechanic couplers.
